(19) United States
(12) Patent Application Publication
(10) Pub. No.: US 2009/0277237 A1
(43) Pub. Date: Nov. 12, 2009

(54) LOCK ARRANGEMENT AND METHOD OF OPERATING THE SAME

(76) Inventor: Zachary Husz, Cudahy, WI (US)

Correspondence Address: MICHAEL BEST & FRIEDRICH LLP, 100 E WISCONSIN AVENUE, Suite 3300, MILWAUKEE, WI, 53202, US

(21) Appl. No.: 12/115,648

(22) Filed: May 6, 2008

(51) Int. Cl. E05B 15/14

(52) U.S. Cl. 70/376

(57) ABSTRACT

A lock arrangement includes a housing defining a longitudinal axis and a keyway substantially parallel to the longitudinal axis, and a lock cylinder positioned within the housing and extending around at least a portion of the keyway. The lock arrangement also includes a tumbler supported in the lock cylinder for movement relative to the lock cylinder between a locked position, in which rotation of the lock cylinder relative to the housing is prevented, and an unlocked position, in which the lock cylinder is rotatable about the longitudinal axis relative to the housing. One of the locked and unlocked positions of the tumbler is changeable after the tumbler is supported in the lock cylinder to code the lock to a key. The lock arrangement further includes an indicator at least partially supportable in the keyway for showing that a key has been inserted into the keyway to code the lock.

### FIELD OF THE INVENTION

This invention relates generally to locks and methods of operating locks, and more particularly to codeable and recodeable locks and methods for determining whether such locks have been coded or operated in any other manner.

### BACKGROUND OF THE INVENTION

Codeable and recodeable locks are often provided with stickers adhered to an exterior surface of the locks to cover an inlet opening to the keyway in the locks.

Such stickers are intended to indicate that a lock is new, or that the lock has not yet been coded. As a result, if a sticker is unintentionally removed (i.e., falls off), there is no way to determine, from a visual inspection of the exterior of the lock, whether or not the lock has been coded.

### SUMMARY

The present invention provides, in one aspect, a lock arrangement including a housing defining a longitudinal axis and a keyway substantially parallel to the longitudinal axis, and a lock cylinder positioned within the housing and being selectively rotatable relative to the housing about the longitudinal axis. The lock cylinder extends around at least a portion of the keyway. The lock arrangement also includes a tumbler supported in the lock cylinder for movement relative to the lock cylinder between a locked position, in which rotation of the lock cylinder relative to the housing is prevented, and an unlocked position, in which the lock cylinder is rotatable about the longitudinal axis relative to the housing. One of the locked and unlocked positions of the tumbler is changeable after the tumbler is supported in the lock cylinder to code the lock to a key. The lock arrangement further includes an indicator at least partially supportable in the keyway for showing that a key has been inserted into the keyway to code the lock.

The present invention provides, in another aspect, a lock arrangement including a housing defining a longitudinal axis, a lock cylinder positioned within the housing and selectively rotatable relative to the housing about the longitudinal axis, and a frangible indicator connected to the lock cylinder such that, after the lock arrangement is installed in a device, the lock cylinder cannot be operated without breaking the indicator.

The present invention provides, in yet another aspect, a method of operating a lock arrangement including providing a lock cylinder supported within a housing for rotating motion relative to the housing about a longitudinal axis at least partially defined between opposite ends of the lock cylinder, positioning a tumbler in the lock cylinder for movement relative to the lock cylinder between a locked position, in which rotation of the lock cylinder relative to the housing is prevented, and an unlocked position, in which the lock cylinder is rotatable about the longitudinal axis relative to the housing, inserting an indicator into a keyway defined in the housing to show whether a key has been inserted into the keyway to code the lock arrangement, and changing one of the locked position and unlocked position of the tumbler after the tumbler is supported in the lock cylinder to code the lock arrangement to a key.

The present invention provides, in a further aspect, a method of operating a lock arrangement including supporting a lock cylinder within a housing for rotating motion relative to the housing about a longitudinal axis at least partially defined between opposite ends of the lock cylinder, and connecting a frangible indicator to the lock cylinder such that, after the lock arrangement is installed in a device, the lock cylinder cannot be operated without breaking the indicator.

The present invention provides, in another aspect, a lock arrangement including a housing defining a longitudinal axis and a keyway substantially parallel to the longitudinal axis, and a lock cylinder positioned within the housing and being selectively rotatable relative to the housing about the longitudinal axis. The lock cylinder extends around at least a portion of the keyway. The lock arrangement also includes a tumbler supported in the lock cylinder for movement relative to the lock cylinder between a locked position, in which rotation of the lock cylinder relative to the housing is prevented, and an unlocked position, in which the lock cylinder is rotatable about the longitudinal axis relative to the housing. One of the locked and unlocked positions of the tumbler is changeable after the tumbler is supported in the lock cylinder to code the lock to a key. The lock arrangement further includes an indicator at least partially supportable on an exterior face of one of the housing and the lock cylinder for showing that a key has been inserted into the keyway to code the lock. An operator grip is defined on an interior portion of the indicator.

Other aspects of the invention will become apparent by consideration of the detailed description and accompanying drawings.

### BRIEF DESCRIPTION OF THE DRAWINGS

FIG. 1 is a front perspective view of a lock arrangement of the present invention, including a codeable lock, in a pre-code configuration, and a coding indicator.

FIG. 2 is a cross-sectional view of the lock arrangement of FIG. 1, along line 2-2 in FIG. 1.

FIG. 3 is a front perspective view of the lock arrangement of FIG. 1, illustrating the coding indicator removed from the codeable lock, and the codeable lock being coded.

FIG. 4a is a top view of a plurality of coding indicators being formed from a sheet of material.

FIG. 4b is a top view of a single coding indicator removed from the sheet of FIG. 4a.

FIG. 4c is a front perspective view of the coding indicator of FIG. 4b, illustrating a plurality of folds formed in the coding indicator in preparation for insertion into the codeable lock of FIG. 1.

FIG. 4d is a front perspective view of the coding indicator of FIG. 4c, illustrating the coding indicator partially formed into its final folded shape.

FIG. 4e is a front perspective view of the coding indicator of FIG. 4d, illustrating the coding indicator almost fully formed into its final folded shape.

FIG. 5a is a side view of the folded coding indicator of FIG. 4e, illustrating the coding indicator aligned for insertion into a keyway of the codeable lock of FIG. 1.

FIG. 5b is a side view of the folded coding indicator of FIG. 5a, illustrating the coding indicator being inserted into the keyway of the codeable lock of FIG. 1.

FIG. 5c is a side view of the folded coding indicator of FIG. 5b, illustrating the coding indicator inserted into the keyway of the codeable lock of FIG. 1.

FIG. 5d is a side view of the folded coding indicator of FIG. 5c, illustrating the distal ends of the coding indicator overlying an exterior face of the codeable lock.

FIG. 6a is a side view of the coding indicator of FIG. 5d, illustrating the coding indicator being removed from the keyway of the codeable lock.

FIG. 6b is a side view of the coding indicator of FIG. 6a, illustrating the coding indicator being unfolded as it is removed from the keyway of the codeable lock.

FIG. 6c is a side view of the coding indicator of FIG. 6b, illustrating a portion of the coding indicator being torn upon continued removal of the coding indicator from the keyway of the codeable lock.

FIG. 6d is a side view of the coding indicator of FIG. 6c, illustrating a portion of the coding indicator being completely removed from the keyway of the codeable lock.

FIG. 7 is a top view of an alternative construction of the coding indicator of FIG. 4b.

FIG. 8a is a side view of the coding indicator of FIG. 7, illustrating the coding indicator inserted within the keyway of the codeable lock of FIG. 1.

FIG. 8b is a side view of the coding indicator of FIG. 8a, illustrating the coding indicator being removed from the keyway of the codeable lock of FIG. 1.

FIG. 9a is a top view of an another alternative construction of the coding indicator of FIG. 4b.

FIG. 9b is a side view of the coding indicator of FIG. 9a, illustrating the coding indicator in its final folded shape aligned for insertion into the keyway of the codeable lock of FIG. 1.

FIG. 10a is a top view of an yet another alternative construction of the coding indicator of FIG. 4b.

FIG. 10b is a side view of the coding indicator of FIG. 10a, illustrating the coding indicator in its final folded shape aligned for insertion into the keyway of the codeable lock of FIG. 1.

FIG. 11a is a top view of another alternative construction of the coding indicator of FIG. 4b.

FIG. 11b is a side view of the coding indicator of FIG. 11a, illustrating the coding indicator in its final folded shape aligned for insertion into the keyway of the codeable lock of FIG. 1.

FIG. 12a is a top view of yet another alternative construction of the coding indicator of FIG. 4b.

FIG. 12b is a side view of the coding indicator of FIG. 12a, illustrating the coding indicator in its final folded shape aligned for insertion into the keyway of the codeable lock of FIG. 1.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and technology used herein is for the purpose of description and should not be regarded as limiting. The use of “including,” “comprising,” and “having” and variations thereof herein is meant to encompass the items listed thereafter and equivalents thereof as well as additional items.

Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

In addition, it is to be understood that phraseology and terminology used herein with reference to device or element orientation (such as, for example, terms like “front,” “rear,” “top,” “bottom,” “lower”, “up,” “down,” etc.) are only used to simplify description of the present invention, and do not alone indicate or imply that the device or element referred to must have a particular orientation. The elements of the present invention can be installed and operated in any orientation desired. In addition, terms such as “first” and “second” are used herein for purposes of description and are not intended to indicate or imply relative importance or significance.

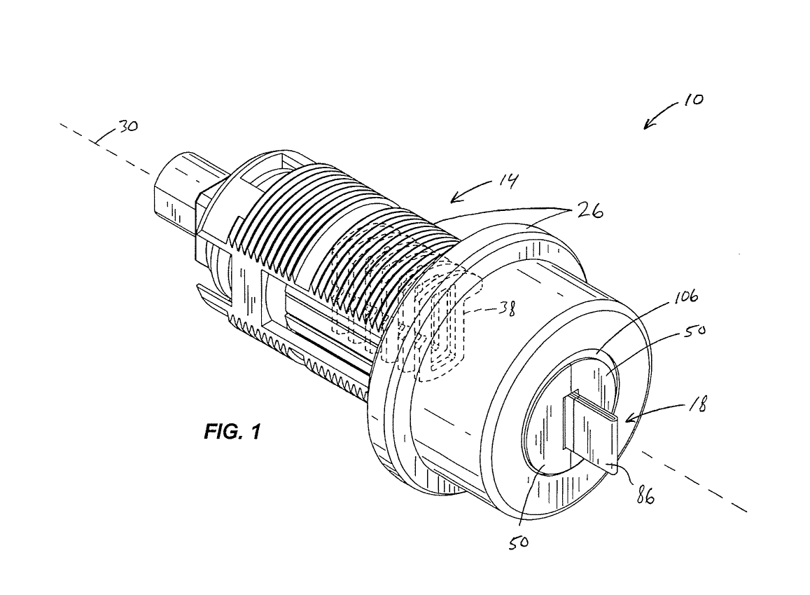

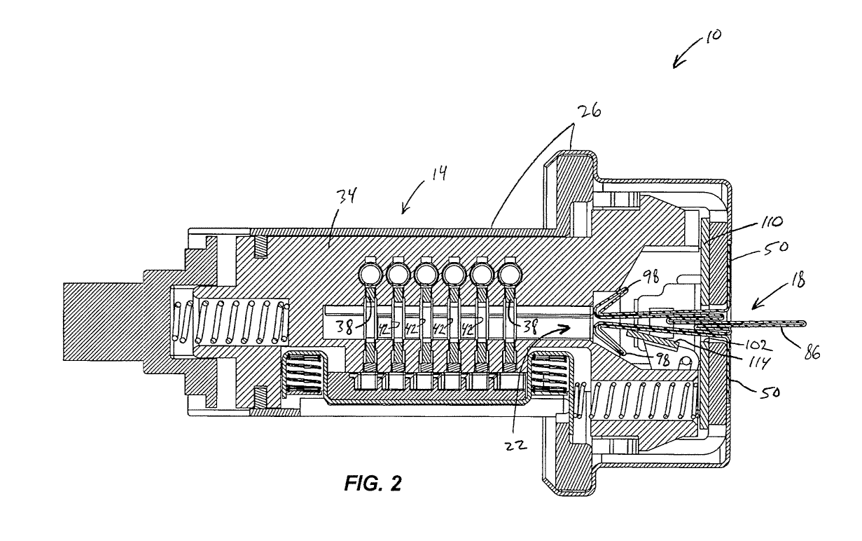

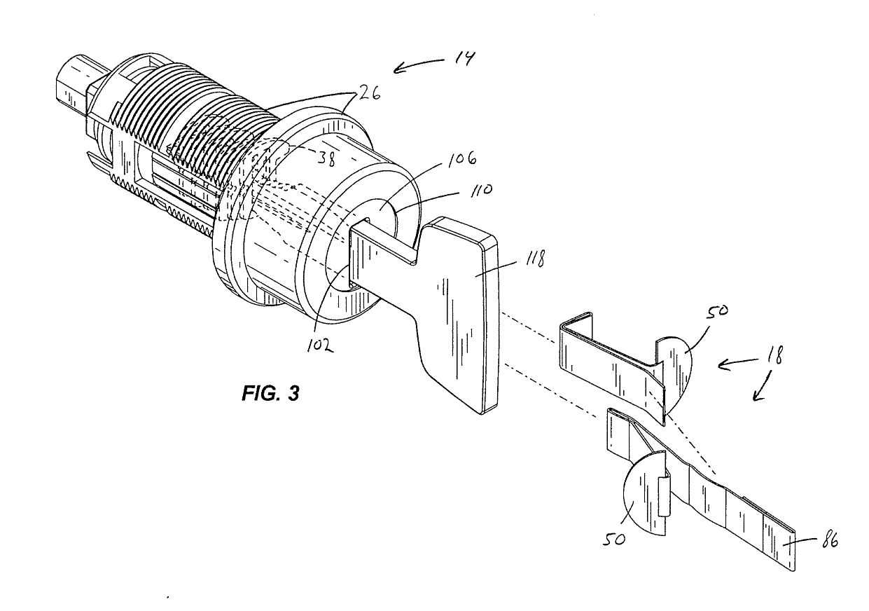

With reference to FIGS. 1 and 2, a lock arrangement 10 includes a codeable lock 14 and a coding indicator 18 at least partially received within a keyway 22 of the codeable lock 14. The codeable lock 14 includes a substantially cylindrical case or housing 26 defining a longitudinal axis 30, and a lock cylinder 34 received within the housing 26. With reference to FIG. 2, the keyway 22 is within the housing 26 and oriented substantially parallel to the longitudinal axis 30, and the lock cylinder 34 defines at least a portion of the keyway 22. The codeable lock 14 also includes a plurality of tumblers 38 received within respective slots 42 in the lock cylinder 34 for movement substantially normal to the longitudinal axis 30 (see FIG. 2). The tumblers 38 are movable within the respective slots 42 in the lock cylinder 34 between a locked position (FIG. 1), in which the lock cylinder 34 is prevented from rotating about the longitudinal axis 30 relative to the housing 26, and an unlocked position (FIG. 3), in which the lock cylinder 34 is free to rotate about the longitudinal axis 30 relative to the housing 26. The structure and operation of the codeable lock 14 illustrated in FIGS. 1-3 is described in more detail in U.S. patent application Ser. No. 12/061,282 filed Apr. 2, 2008, the entire content of which is incorporated herein by reference. Alternative constructions of the lock arrangement 10, however, may incorporate any of the codeable or recodeable locks disclosed in U.S. patent application Ser. No. 12/061,282.

With reference to FIGS. 1 and 2, the coding indicator 18 is received within the keyway 22 of the codeable lock 14 to provide a visual indication that the lock 14 is new or has not yet been coded. As will be described in greater detail below, the coding indicator 18 is configured to substantially prevent unintentional removal of the indicator 18 from the codeable lock 14, such that one or more intentional acts are required to remove the indicator 18 from the codeable lock 14. As such, one viewing the codeable lock 14 with the coding indicator 18 removed could conclude with a high degree of certainty that the lock 14 has been tampered with or has already been coded to operate with a particular key.

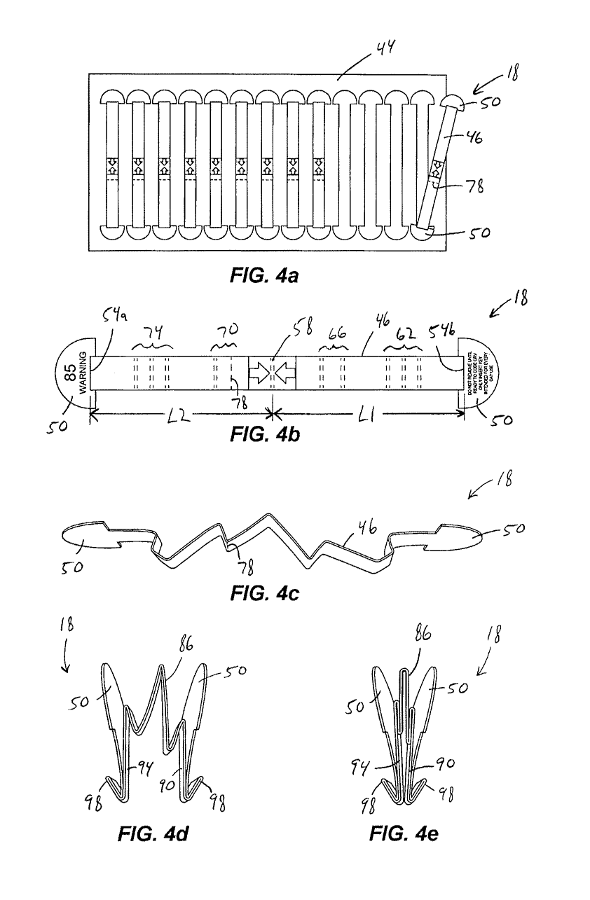

With reference to FIGS. 4a and 4b, the illustrated coding indicator 18 is configured as a substantially flat, thin piece of material that is folded into a final shape before insertion into the keyway 22 of the codeable lock 14. Specifically, the coding indicator 18 is made from a frangible material (e.g., a sheet of paper 44, see FIG. 4a) having an elongated strip 46 and respective tabs 50 coupled to opposite ends 54a, 54b of the strip 46. Alternatively, the coding indicator 18 may be made from a thin sheet of plastic material or any other frangible material. As a further alternative, the coding indicator 18 may be configured with a substantial thickness dimension, and manufactured using any of a number of different processes (e.g., molding, etc.).

With reference to FIG. 4b, the coding indicator 18 includes a center fold line 58 identified by a pair of facing allows. In the illustrated construction of the coding indicator 18, the arrows are printed on the sheet of paper 44 before the individual coding indicators 18 are cut from the sheet of paper 44. Alternatively, any of a number of different graphics or symbols may be used to indicate the location of the center fold line 58. With continued reference to FIG. 4b, a length dimension L1 between the end 54b of the strip 46 and the center fold line 58 is unequal to a length dimension L2 between the end 54a of the strip 46 and the center fold line 58. In the illustrated construction of the coding indicator 18, a ratio of the length dimensions L1/L2 is about 1.1:1. Alternatively, depending upon the number and location of the plurality of folds in the strip 46, the ratio of the length dimensions L1/L2 may be greater than or less than about 1.1:1. As a further alternative, the center fold line may be centrally disposed on the strip such that the ratio of the length dimensions L1/L2 may be equal to about 1:1. The purpose for offsetting the center fold line 58 relative to the respective ends 54a, 54b of the strip 46 is discussed in greater detail below.

With continued reference to FIG. 4b, the portion of the strip 46 coinciding with the length dimension L1 includes a first group 62 of fold lines and a second group 66 of fold lines. Likewise, the portion of the strip 46 coinciding with the length dimension L2 includes a third group 70 of fold lines and a fourth group 74 of fold lines. Each of the first and fourth groups 62, 74 of fold lines on the coding indicator 18 includes 3 fold lines, with equal spacing between any two adjacent fold lines in the respective groups 62, 74, and each of the second and third groups 66, 70 of fold lines on the coding indicator 18 includes two fold lines, with the second group 66 of fold lines located between the first group 62 of fold lines and the center fold line 58, and the third group 70 of fold lines located between the fourth group 74 of fold lines and the center fold line 58. During manufacture of the coding indicators 18, however, the fold lines corresponding with each of the groups 62, 66, 70, 74 may or may not be printed or otherwise indicated on the strip 46. In either case, an automated process may be employed to create the folds corresponding with each of the fold lines in the groups 62, 66, 70, 74 with accuracy and precision.

In the illustrated construction of the coding indicator 18, one of the fold lines in the third group 70 is perforated (for reasons discussed in greater detail below) by a punching process. Specifically, as shown in FIG. 4b, a fold line 78 in the third group 70 is perforated. Alternatively, any of the fold lines in the third and fourth groups 70, 74 may be perforated in a similar manner, or a separate perforated line that is substantially parallel with the fold lines in the third and fourth groups 70, 74 may be formed in the portion of the strip 46 coinciding with the length dimension L2.

When the coding indicator 18 is folded into its final shape, the second and third groups 66, 70 of fold lines yield a central handle or grip portion 86 between the respective second and third groups 66, 70 of fold lines (see FIG. 4d). In addition, the second group 66 of fold lines yields a first leg portion 90 between the second group 66 of fold lines and the end 54b of the strip 46, and the third group 70 of fold lines yields a second leg portion 94 between the third group 70 of fold lines and the end 54a of the strip 46.

With reference to FIGS. 4b-4d, the first group 62 of fold lines, when the coding indicator 18 is folded into its final shape, yields a foot portion 98 on the first leg portion 90 (see FIG. 4d). Likewise, the fourth group 74 of fold lines, when the coding indicator 18 is folded into its final shape, yields another foot portion 98 on the second leg portion 94. With reference to FIGS. 4d and 4e, the grip portion 86 and the first leg portion 90 at least partially overlap one another, and the grip portion 86 and the second leg portion 94 at least partially overlap one another. As a result of the ratio of the length dimensions L1/L2 (see FIG. 4b), the overlap between the grip portion 86 and the first leg portion 90 is greater than the overlap between the grip portion 86 and the second leg portion 94.

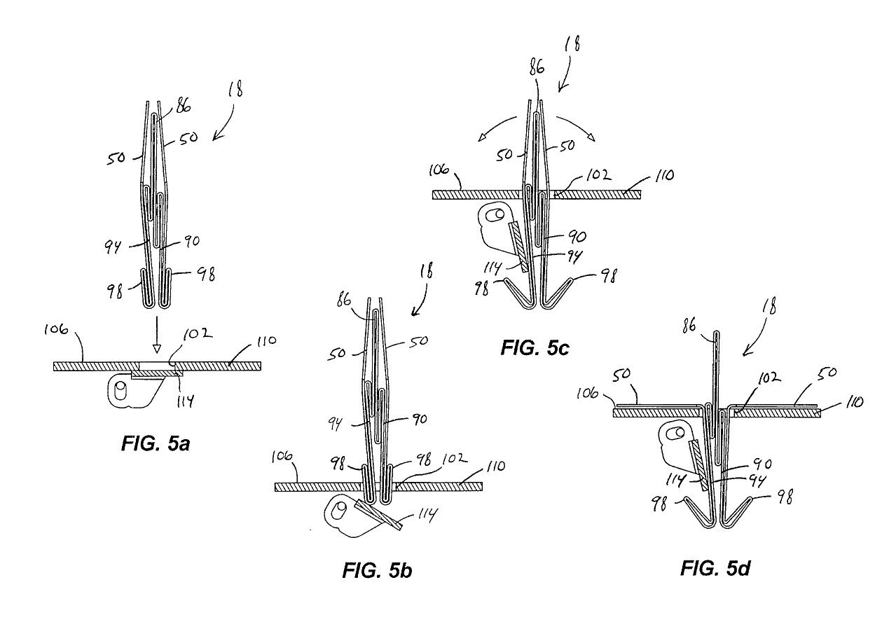

With reference to FIGS. 5a-5d, the coding indicator 18, folded into its final shape, is shown as being inserted into the keyway 22 of the codeable lock 14, a portion of which is at least partially defined by a key slot 102 in an exterior surface 106 of the codeable lock 14. In the illustrated construction of the codeable lock 14, the key slot 102 is formed in a shutter plate 110 coupled for rotation with the lock cylinder 34, and a shutter 114 is pivotably coupled to the shutter plate 110 to selectively block the key slot 102. A more detailed description of the shutter plate 110 and shutter 114 can be found in U.S. patent application Ser. No. 12/061,282. Alternatively, the key slot 102 may be formed in a portion of the housing 26 or another component of the codeable lock 14 to allow access to the keyway 22. Initially, the leg portions 90, 94 of the coding indicator 18 are pinched together and aligned with the key slot 102 (FIG. 5a). Then, as shown in FIG. 5b, continued insertion of the respective leg portions 90, 94 of the coding indicator 18 through the key slot 102 causes the shutter 114 to pivot relative to the shutter plate 110 toward an open position, allowing access to the keyway 22.

When the leg portions 90, 94 extend into the keyway 22 to the depth shown in FIG. 5c, continued insertion of the coding indicator 18 is halted, and the tabs 50 coupled to the respective ends 54a, 54b of the strip 46 are folded away from the grip portion 86 toward the exterior surface 106 of the codeable lock 14 to lie flat against the exterior surface 106. With reference to FIG. 4b, each of the tabs 50 includes a graphic, symbol, or text that provides an instruction to not remove the coding indicator 18 from the keyway 22 until the codeable lock 14 is ready to be coded. When the tabs 50 are laid flat against the exterior surface 106 of the codeable lock 14, as shown in FIG. 5d, the graphics, symbols, or text on the respective tabs 50 may be viewed as a whole. Alternatively, one or both of the tabs 50 may be color-coded, or include a number or series of numbers and/or letters or other characters to correlate a particular lock configuration with a particular vehicle manufacturer. Each of the tabs 50 may also include a layer of adhesive to secure the tabs 50 to the exterior surface 106 of the codeable lock 14. Alternatively, the adhesive may be previously applied to the exterior surface 106, rather than being directly applied to the tabs 50.

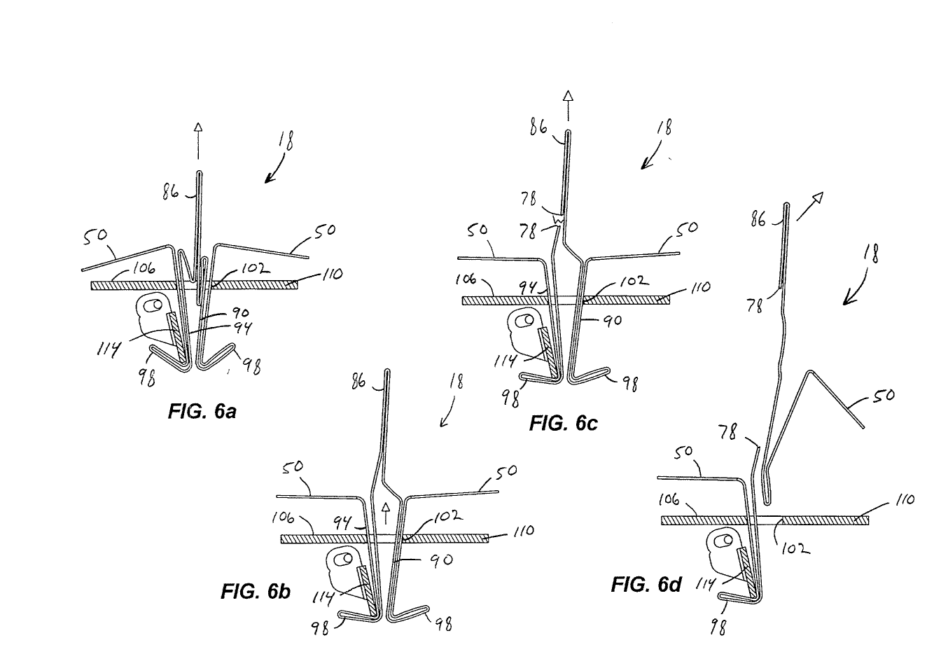

When it is desired to remove the coding indicator 18 from the keyway 22 of the codeable lock 14, the grip portion 86 of the indicator 18 may be grasped and pulled in a direction substantially parallel to the longitudinal axis 30 away from the exterior surface 106 of the lock 14 (see FIG. 6a). Initially pulling on the grip portion 86, from the position of the indicator 18 as shown in FIG. 5d, causes the tabs 50 to move away from the exterior surface 106 of the lock 14, allowing at least some of the folds corresponding with the second and third groups 66, 70 to begin to unfold. With reference to FIG. 6b, continued pulling on the grip portion 86, when the foot portion 98 is engaged or hooked by the shutter 114, causes the overlap between the grip portion 86 and the second leg portion 94 to be reduced as the folds corresponding with the third group 70 of fold lines straighten. Likewise, the continued pulling on the grip portion 86 causes the overlap between the grip portion 86 and the first leg portion 90 to be reduced as the folds corresponding with the second group 66 of fold lines straighten.

As a result of the ratio of the length dimensions L1/L2, the overlap between the grip portion 86 and the second leg portion 94 is substantially eliminated and the folds responding with the third group 70 are substantially straightened before the folds corresponding with the second group 66 are substantially straightened. Further, continued pulling on the grip portion 86 directs substantially the entire force applied to the grip portion 86 through the portion of the strip 46 corresponding with the length dimension L2, causing the strip 46 to separate or break along the perforated fold line 78 in the third group 70 (see FIG. 6c). Subsequently, the coding indicator 18 may be removed from the keyway 22 in two pieces (see FIG. 6d). As discussed above, one viewing the codeable lock 14 with the coding indicator 18 removed, partially removed, or broken along the perforated fold line 78 in the third group 70 could conclude with a high degree of certainty that the lock 14 has been tampered with or has already been coded to operate with a particular key.

With reference to FIG. 3, the coding indicator 18 is completely removed from the keyway 22 of the codeable lock 14, and the lock 14 is ready to be coded. To code the lock 14, one would insert a key 118 through the key slot 102 and into the keyway 22, causing the tumblers 38 disposed in the lock cylinder 34 to displace in a direction substantially normal to the longitudinal axis 30 according to the profile of the particular key 118. The resultant positions of the tumblers 38 within the lock cylinder 34 define the unlocked positions of the tumblers 38, in which the lock cylinder 34 is free to rotate relative to the housing 26. As previously mentioned, U.S. patent application Ser. No. 12/061,282 includes a more detailed discussion on the procedure for coding the lock 14.

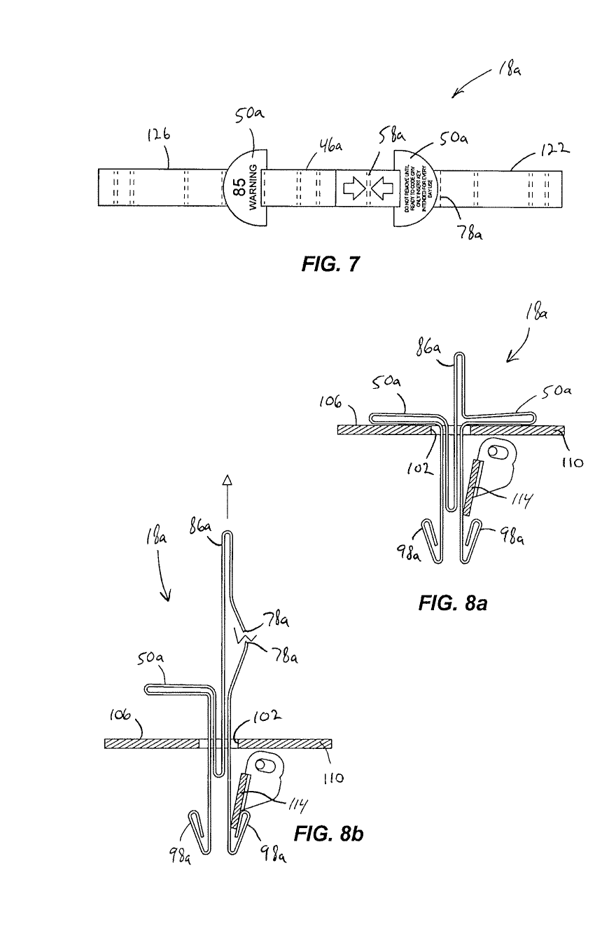

FIGS. 7-8b illustrate an alternative construction of a coding indicator 18a, with like components and features having like reference numerals, with the letter “a.” In this construction of the coding indicator 18a, additional strips 122, 126 are coupled to the arcuate edges of the respective tabs 50a, and a perforated fold line 78a is positioned on the strip 122 adjacent the tab 50a (See FIG. 7). With reference to FIG. 8a, the coding indicator 18a is shown folded into its final shape and inserted through the key slot 102 of the codeable lock 14. Upon removal of the coding indicator 18a from the key slot 102, the indicator 18a will break along the perforated fold line 78a, in a manner similar to that described above with reference to the coding indicator 18, such that the coding indicator 18a is removed in two separate pieces (see FIG. 8b).

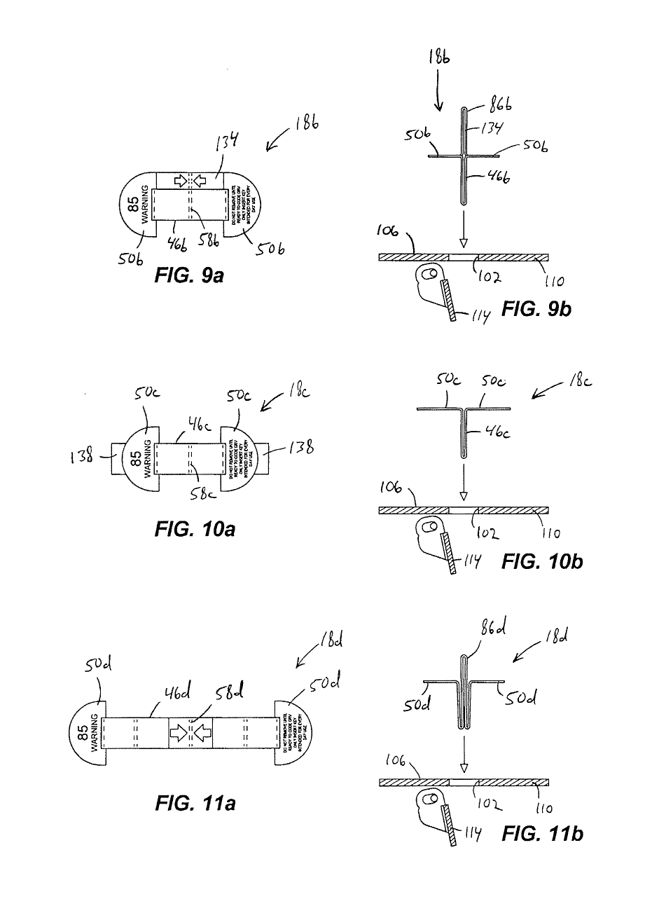

FIGS. 9a and 9b illustrate another alternative construction of a coding indicator 18b, with like components and features having like reference numerals, with the letter “b.” In this construction of the coding indicator 18b, a second strip 134, extending substantially parallel to the strip 46b, is positioned between and is coupled to each of the tabs 50b (see FIG. 9a). Although the strips 46b, 134 share a common center fold line 58b located approximately midway between the respective ends of the strip 46b, the strip 46b is folded in one direction relative to the tabs 50b for insertion through the key slot 102, and the strip 134 is folded in an opposite direction relative to the tabs 50b to form the grip portion 86b of the indicator 18b (see FIG. 9b).

FIGS. 10a and 10b illustrate yet another alternative construction of a coding indicator 18c, with like components and features having like reference numerals, with the letter “c.” In this construction of the coding indicator 18c, a grip portion is omitted when the indicator 18c is folded into its final shape. Instead, each of the tabs 50c includes an ear 138 that may be grasped to remove the indicator 18c from the key slot 102.

FIGS. 11a and 11b illustrate another alternative construction of a coding indicator 18d, with like components and features having like reference numerals, with the letter “d.” In each of the coding indicators 18b, 18c, 18d of FIGS. 9a-11b, the center fold lines 58b, 58c, 58d are located approximately midway between the ends of the respective strips 46b, 46c, 46d, and a perforated fold line is omitted.

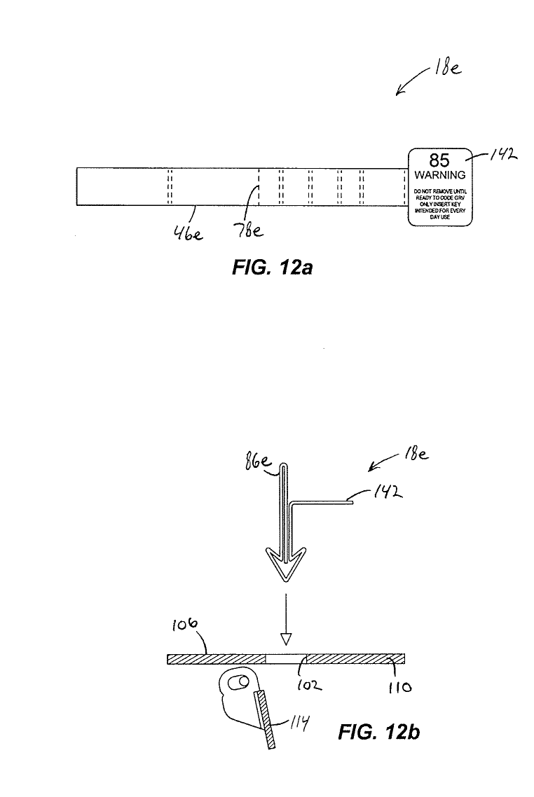

FIGS. 12a and 12b illustrate yet another alternative construction of a coding indicator 18e, with like components and features having like reference numerals, with the letter “e.” In this construction of the coding indicator 18e, a single tab 142, including all of the graphics, symbols, or text that provide an instruction to not remove the coding indicator 18e from the keyway 22 until the codeable lock 14 is ready to be coded, is coupled to one of the ends of the strip 46e. With reference to FIG. 12b, when the coding indicator 18e is folded into its final shape, the tab 142 is disposed on one side of the grip portion 86e of the indicator 18e.

Although particular embodiments of the present invention have been shown and described, other alternative embodiments will be apparent to those skilled in the art and are within the intended scope of the present invention.

What is claimed is:

1. A lock arrangement comprising:
a housing defining a longitudinal axis and a keyway substantially parallel to the longitudinal axis;
a lock cylinder positioned within the housing and being selectively rotatable relative to the housing about the longitudinal axis, the lock cylinder extending around at least a portion of the keyway;
a tumbler supportable in the lock cylinder for movement relative to the lock cylinder between a locked position, in which rotation of the lock cylinder relative to the housing is prevented, and an unlocked position, in which the lock cylinder is rotatable about the longitudinal axis relative to the housing, one of the locked and unlocked positions of the tumbler being changeable after the tumbler is supported in the lock cylinder to code the lock to a key; and
an indicator at least partially supportable in the keyway for showing that a key has been inserted into the keyway to code the lock.

2. The lock arrangement of claim 1, wherein the indicator is frangible.

3. The lock arrangement of claim 1, wherein the indicator includes a perforation to determine a location of a break indicative of one of a key having been inserted into the keyway and the indicator having been tampered with.

4. The lock arrangement of claim 1, further comprising a shutter moveable across an inlet opening of the keyway, and wherein the shutter maintains the indicator in the keyway.

5. The lock arrangement of claim 1, wherein opposite ends of the indicator extend outwardly from the keyway across an exterior surface of the housing.

6. The lock arrangement of claim 5, wherein a fold formed between the opposite ends of the indicator extends outwardly from the keyway beyond the exterior surface of the housing, and wherein the fold at least partially defines an operator grip of the indicator.

7. The lock arrangement of claim 1, wherein the indicator includes a plurality of folds, and wherein at least one of the plurality of folds maintains the indicator in the keyway.

8. The lock arrangement of claim 1, wherein the indicator is inserted into the keyway after the lock is assembled and before the lock is coded.

9. The lock arrangement of claim 1, wherein an operator grip is defined on a middle portion of the indicator.

10. The lock arrangement of claim 1, wherein the indicator includes a first member extending into the keyway and a second member extending across an exterior surface of one of the housing and the lock cylinder.

11. A lock arrangement comprising:
a housing defining a longitudinal axis;
a lock cylinder positioned within the housing and selectively rotatable relative to the housing about the longitudinal axis; and
a frangible indicator connected to the lock cylinder such that, after the lock arrangement is installed in a device, the lock cylinder cannot be operated without breaking the indicator.

12. The lock arrangement of claim 11, further comprising a tumbler supported in the lock cylinder for movement relative to the lock cylinder between an unlocked position, in which the lock cylinder is rotatable about the longitudinal axis relative to the housing, and a locked position, in which rotation of the lock cylinder relative to the housing is prevented, one of the locked and unlocked positions of the tumbler being changeable to code the lock to a key.

13. The lock arrangement of claim 12, wherein the housing defines a keyway substantially parallel to the longitudinal axis, wherein the lock cylinder extends around at least a portion of the keyway, and wherein the indicator is at least partially supportable in the keyway for showing whether a key has been inserted into the keyway to code the lock.

14. The lock arrangement of claim 11, wherein at least a part of the indicator extends into the housing.

15. The lock arrangement of claim 11, wherein the indicator includes a perforation to determine a location of a break indicative of one of the indicator having been tampered with and a key having been inserted into a keyway defined by the housing in a direction substantially parallel to the longitudinal axis.

16. The lock arrangement of claim 15, wherein opposite ends of the indicator extend outwardly from the keyway across an exterior surface of the housing.

17. The lock arrangement of claim 16, wherein a fold formed between the opposite ends of the indicator extends outwardly from the keyway beyond the exterior surface of the housing.

18. The lock arrangement of claim 17, wherein the fold at least partially defines an operator grip of the indicator.

19. The lock arrangement of claim 11, wherein the indicator includes a plurality of folds, and wherein at least one of the plurality of folds maintains the indicator connected to the lock cylinder.

20. The lock arrangement of claim 11, wherein an operator grip is defined on a middle portion of the indicator.

21. The lock arrangement of claim 11, further comprising a keyway within the housing and oriented substantially parallel to the longitudinal axis, wherein the lock cylinder defines at least a portion of the keyway, and wherein the indicator includes a first member extending into the keyway and a second member extending across an exterior surface of one of the housing and the lock cylinder to maintain the first member in the keyway.

22. A method of operating a lock arrangement, the method comprising the acts of:
providing a lock cylinder supported within a housing for rotating motion relative to the housing about a longitudinal axis at least partially defined between opposite ends of the lock cylinder;
positioning a tumbler in the lock cylinder for movement relative to the lock cylinder between a locked position, in which rotation of the lock cylinder relative to the housing is prevented, and an unlocked position, in which the lock cylinder is rotatable about the longitudinal axis relative to the housing;
inserting an indicator into a keyway located within the housing to show whether a key has been inserted into the keyway to code the lock arrangement; and
changing one of the locked position and unlocked position of the tumbler after the tumbler is supported in the lock cylinder to code the lock arrangement to a key.

23. The method of claim 22, wherein inserting the indicator into the keyway includes inserting a frangible portion of the indicator into the keyway.

24. The method of claim 22, further comprising providing the indicator with a perforation to predetermined a location of a break.

25. The method of claim 24, further comprising inserting a key into the keyway after the indicator is broken along the perforation.

26. The method of claim 22, wherein inserting the indicator into the keyway includes folding opposite ends of the indicator outwardly from the keyway across an exterior surface of the housing.

27. The method of claim 22, wherein inserting the indicator into the keyway includes
forming a fold between opposite ends of the indicator; and
extending the fold outwardly from the keyway beyond the exterior surface of the housing, wherein the fold at least partially defines an operator grip of the indicator.

28. The method of claim 22, wherein the indicator includes a plurality of folds, and wherein inserting the indicator into the keyway includes maintaining the indicator in the keyway with at least one of the plurality of folds.

29. The method of claim 22, wherein the indicator is inserted into the keyway after the lock is assembled and before the lock is coded.

30. The method of claim 22, further comprising griping an operator grip defined on a middle portion of the indicator to remove the indicator from the keyway prior to changing the one of the locked position and the unlocked position of the tumbler.

31. The method of claim 22, wherein inserting the indicator into the keyway includes inserting a first member of the indicator into the keyway, and further comprising positioning a second member across an exterior surface of one of the housing and the lock cylinder to maintain the first member in the keyway.

32. A method of operating a lock arrangement, the method comprising the acts of:
supporting a lock cylinder within a housing for rotating motion relative to the housing about a longitudinal axis at least partially defined between opposite ends of the lock cylinder; and
connecting a frangible indicator to the lock cylinder such that, after the lock arrangement is installed in a device, the lock cylinder cannot be operated without breaking the indicator.

33. The method of claim 32, further comprising supporting a tumbler in the lock cylinder for movement relative to the lock cylinder between an unlocked position, in which the lock cylinder is rotatable about the longitudinal axis relative to the housing, and a locked position, in which rotation of the lock cylinder relative to the housing is prevented, and changing one of the locked position and the unlocked position of the tumbler to code the lock to a key.

34. The method of claim 32, further comprising a keyway within the housing and oriented substantially parallel with the longitudinal axis, wherein the lock cylinder defines at least a portion of the keyway, and wherein connecting the indicator to the lock cylinder includes at least partially supporting the indicator in the keyway for showing whether a key has been inserted into the keyway to code the lock.

35. The method of claim 32, further comprising a keyway within the housing and oriented substantially parallel with the longitudinal axis, wherein the lock cylinder defines at least a portion of the keyway, and wherein the method further comprises forming a perforation on the indicator to predetermine a location of a break.

36. The method of claim 35, further comprising inserting a key into the keyway after the indicator is broken along the perforation.

37. The method of claim 32, wherein at least a part of the indicator extends into a keyway located within the housing, and further comprising folding opposite ends of the indicator outwardly from the keyway across an exterior surface of the housing.

38. The method of claim 32, further comprising a keyway located within the housing, and wherein connecting the indicator to the lock cylinder includes
forming a fold between opposite ends of the indicator; and
extending the fold outwardly from the keyway beyond the exterior surface of the housing.

39. The method of claim 38, wherein forming the fold at least partially defines an operator grip of the indicator.

40. The method of claim 32, further comprising forming a plurality of folds in the indicator and holding the indicator in the lock cylinder with at least one of the plurality of folds.

41. The method of claim 32, further comprising griping an operator grip defined on a middle portion of the indicator to remove the indicator from the lock cylinder.

42. The method of claim 32, further comprising a keyway within the housing, wherein connecting the frangible indicator to the lock cylinder includes inserting a first member of the indicator into the keyway, and wherein the method further comprises positioning a second member across an exterior surface of one of the housing and the lock cylinder to maintain the first member in the keyway.

43. A lock arrangement comprising:
a housing defining a longitudinal axis and a keyway substantially parallel to the longitudinal axis;
a lock cylinder positioned within the housing and being selectively rotatable relative to the housing about the longitudinal axis, the lock cylinder extending around at least a portion of the keyway;
a tumbler supported in the lock cylinder for movement relative to the lock cylinder between a locked position, in which rotation of the lock cylinder relative to the housing is prevented, and an unlocked position, in which the lock cylinder is rotatable about the longitudinal axis relative to the housing, one of the locked and unlocked positions of the tumbler being changeable after the tumbler is supported in the lock cylinder to code the lock to a key; and
an indicator at least partially supportable on an exterior face of one of the housing and the lock cylinder for showing that a key has been inserted into the keyway to code the lock, an operator grip being defined on a middle portion of the indicator.

44. The lock arrangement of claim 43, wherein the indicator is at least partially supportable in the keyway for showing that a key has been inserted into the keyway to code the lock.

45. The lock arrangement of claim 43, wherein the indicator is frangible.

46. The lock arrangement of claim 43, wherein the indicator includes a perforation to determine a location of a break indicative of one of a key having been inserted into the keyway and the indicator having been tampered with.

47. The lock arrangement of claim 43, wherein the indicator is at least partially supported in the keyway, wherein the indicator includes a plurality of folds, and wherein at least one of the plurality of folds maintains the indicator in the keyway.

48. The lock arrangement of claim 43, wherein the indicator is inserted into the keyway after the lock is assembled and before the lock is coded.
